(19) United States
(12) Patent Application Publication
(10) Pub. No.: US 2025/0334408 A1
(43) Pub. Date: Oct. 30, 2025

(54) REMOTE ORDNANCE IDENTIFICATION AND CLASSIFICATION SYSTEM UTILIZING ARTIFICIAL INTELLIGENCE AND UNMANNED AERIAL VEHICLE FUNCTIONALITY

(71) Applicant: HOWARD G. BUFFETT FOUNDATION, Decatur, IL (US)

(72) Inventors: Howard G. BUFFETT, Decatur, IL (US); Mark RIGEL, Decatur, IL (US); Gabriel L. RUBIO, Decatur, IL (US); Matthew WELLNER, Decatur, IL (US); Patel HARSHIL, Decatur, IL (US)

(21) Appl. No.: 18/167,710

(22) Filed: Feb. 10, 2023

(51) Int. Cl. G01C 15/00; G05D 1/221; G05D 101/15; G05D 105/85; G05D 107/30; G05D 109/20; G05D 111/10; G05D 111/30; G05D 111/67

(52) U.S. Cl. CPC G01C 15/002; G05D 1/221; G05D 2101/15; G05D 2105/85; G05D 2107/34; G05D 2109/20; G05D 2111/17; G05D 2111/30; G05D 2111/67

(57) ABSTRACT

A system and processes detect, identify a Unexploded Ordnances (UXOs) and/or categorize UXOs in near real-time using Unmanned Aerial Vehicles (UAVs). In accordance with various disclosed embodiments, the equipment includes such UAVs (also referred to herein as “drones,”) that include a plurality of sensors for imaging the terrain of a geographic area to analyze the terrain and detect anomalies and/or changes that may be indicative location of UXOs, for example, soil moving activity performed in association with the burying the UXO. Additionally, the UAVs include processing equipment, e.g., one or more small form factor devices, e.g., Next Unit of Computing (NUC) compute elements or the like, that provide processing power to provide EDGE computing on the data gathered at the UAV.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

Disclosed embodiments are directed to Unmanned Aerial Vehicle (UAV) related technology for detecting and identifying unmarked explosive devices and other conflict zone related locations. More specifically, disclosed embodiments are directed to UAVs including a plurality of sensors for detecting, identifying and categorizing buried, or partially buried UneXploded Ordnance (UXO) and other conflict zone areas including, for example, unmarked graves.

### BACKGROUND

Armed conflict between different groups is as old as history itself. Likewise, the conflict directed between military members of those different groups often envelops civilians not engaged in active fighting for one side or another. Thus, history is full of situations in which civilians, i.e., people who are not part of the conflict, are injured or killed as a result of their presence in an area that becomes a “conflict zone.” Indeed, there is often very little to anything that can be done by those civilians to avoid this other than leaving a geographic area once hostilities have commenced.

Although evacuating is one possibility for avoiding the casualties of war, there are undeniably valuable reasons for civilians staying in a conflict zone. For example, the very nature of agriculture requires that farmers care for their land in order to raise crops to feed others. Although growing seasons range based on crop and geography, once land is prepared and seeded for crops, the area must be cared for in order to facilitate crop cultivation. Therefore, evacuating a geographic area because it has become part of a conflict zone negatively affects not only the farmer and their family but also those people that are part of the agricultural supply chain in which the farmer's crops exist.

For this reason, and others, attacking an agricultural supply chain has been recognized by combatants as an effective weapon in warfare as well. History is replete with battles and wars that have been won or lost as a result of inadequate supplies. An unfed or underfed people are much easier to control and conquer than one that is healthy and well nourished. As a result, for centuries, in times of war, countries have sought to disrupt agricultural supply chains, destroy crops and cripple their enemies' ability to feed and care for their land and people. In fact, attacks against agriculture, or for control of it, are as old as war itself.

In the last two centuries, this interrelationship has manifested itself in destruction of agricultural equipment, seeds, water conduits, and the seeding of crop bearing soil with explosive devices that would injury or kill the farmers themselves. It may be that the most effective attack on any agricultural supply chain is an attack on those farmers because they are the intelligence that enables human society to nurture crops in the earth to feed our population. By destroying or deterring that intelligence from such activities, there is no agriculture that may be shepherded by our supply chains.

It is for this reason that warfare in the last two centuries has turned to seeding agricultural fields with Improvised Explosive Devices (IEDs) meant to injure or kill those working in the fields. Over a growing season, the soil in which crops grow is shaped and cared for to benefit the crops that grow in it. For example, the tilling of soil enables mixing in organic matter but also helps control weeks and loosen up areas of crusted soil for planting of seeds. This process focuses only on the top most layer of the soil, e.g., to a depth of less than one foot (approximately one third of a meter). However, this is the exact depth of activity that can and will trigger detonation of an IED or other UXO (e.g., anti-tank mines, remnants of Multiple Launch Rocket System (MLRS) equipment and artillery ammunition).

Hereafter, the term “UXO” and the term “ordnance” is used to collectively refer to explosive ordnance including conventional munitions containing explosives, as well as mines, booby traps and other devices including any explosive ordnance that has been primed, fused, armed, or otherwise prepared for use and used in an armed conflict, including abandoned explosive ordnance means or explosive remnants of war).

As a result, it is a well-known strategy to bury ordnance for use to actively destroy or disable enemy targets such as combatants, vehicles, tanks, etc. but also to bury such ordnance to deter future use of geographic areas, e.g., strategic pathways and road, as well as agricultural fields during conflict and following retreat of a military force. This type of agricultural terrorism is meant to cripple the agricultural capability of a region by injuring or killing farmers but also to paralyze communities from recovering from such loses by deterring others from taking their place as growers of food. The use of such buried ordnance enables a military power to maximize their negative effect on their enemies because these ordnance serve as indiscriminate weapons that continue to be dangerous long after a particular conflict has ended, harming both civilians and an economy in need of reestablishment. The loss of human productivity through injury or death is the most immediate loss associated with buried ordnances. However, it is the concept of “access denial,” i.e., a people's loss of land use, that can cripple the recovery of a community from warfare. The potential for the presence of a single buried ordnance can dissuade working of agricultural fields to re-establish agricultural economic practices that lead to reconstruction and post-conflict re-development.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to the more detailed description below.

Disclosed embodiments provide a system and processes for detecting and identifying UXOs in near real-time using UAVs. In accordance with various disclosed embodiments, the equipment includes such UAVs (also referred to herein as “drones,”) that include a plurality of sensors for imaging the terrain of a geographic area to analyze the terrain and detect anomalies and/or changes that may be indicative location of UXOs, for example, soil moving activity performed in association with the burying the UXO. Additionally, the UAVs include processing equipment, e.g., one or more small form factor devices, e.g., Next Unit of Computing (NUC) compute elements or the like, that provide processing power to provide EDGE computing on the data gathered at the UAV.

In accordance with at least some disclosed embodiments, near real time geospatial analysis tools are provided using sensor data generated by InfraRed (IR) sensors, Electro-Optical (EO) sensors, Synthetic Aperture Radar (SAR) sensors, and Laser Imaging Detection and Ranging (LiDAR) sensors (without limitation) located on a UAV. Accordingly, it should be understood that various disclosed embodiments associate the data from the different sensor types with the location at which it was gathered.

In accordance with at least some disclosed embodiments, the location data to be associated with the gathered sensor data is provided by utilizing the location data utilized to control travel of the UAV.

Additionally, the data from the different sensor types may be analyzed to formulate more informed analytics based on the different and disparate data generated by each of sensors through sensor fusion functionality.

In addition, in accordance with disclosed embodiments, the data generated by the plurality of sensors and data relating to subsequent removal and neutralization of detected objects may be used to further refine the change detection, identification and categorization analyses through machine learning to assist in facilitating sensor fusion functionality.

In accordance with disclosed embodiments, scanning and analysis of a particular geographic area (referred to herein as “surveying”) may be performed as a single event or may be performed on a periodic basis.

For example, in accordance with at least some disclosed embodiments, the plurality of sensors may generate sensor data that enables change detection analysis that analyzes the terrain of a geographic area for one or more changes in analyzed characteristics since a last analysis was performed for the geographic area. This type of change detection analysis may be used to identify locations for further analysis as a potential cite of a UXO. Alternatively, or in addition, the data generated by the plurality of sensors may also be analyzed to identify values of sensed characteristics that indicative of a potential cite of a UXO. In this way, multiple surveys of a particular geographical area need not be required to identify locations for further analysis as a potential cite of a UXO.

In accordance with some disclosed embodiments, the data generated by the plurality of sensors may be analyzed and compared with reference data to perform object recognition analysis, for example, to make an identification of a buried object based on the sensor data generated at the location of the detected object. In addition, or in the alternative, the data generated by the plurality of sensors may be analyzed and compared with reference data to perform categorization of detected objects.

In accordance with various disclosed embodiments, some degree of functionality for performing the change detection, identification and categorization analyses may be performed in an automated or semi-automated manner.

### BRIEF DESCRIPTION OF THE FIGURES

These and other features of the present disclosure will become more apparent from the following description of the illustrative embodiments.

FIG. 1 illustrates an example of a remote ordnance identification and classification system including an exemplary implementation of UAV-based, multi-module sensor system functionality in accordance with disclosed embodiments.

FIG. 2 illustrates an example and type of data communication performed between UAV-based, multi-module sensor system equipment and various ground based processors in accordance with the disclosed embodiments.

FIG. 3 illustrates an example of UAV-based, multi-module sensor system components and onboard processing functionality provided in accordance with various disclosed embodiments.

FIG. 4 illustrates one representational depiction of the operations performed to utilize flight controller software for registering UAV-based, multi-module sensor system sensor generated data with GPS location data for subsequent transmission to pyrotechnic team personnel equipment for their use.

FIG. 5 illustrates a further representational depiction of the communications operations performed to utilize flight controller software for registering UAV-based, multi-module sensor system sensor generated data with GPS location data in accordance with various disclosed embodiments.

FIG. 6 illustrates an example of a User Interface (UI) generated and output on one or more computers including survey analytics processors in accordance with various disclosed embodiments.

### DETAILED DESCRIPTION

The description of specific embodiments is not intended to be limiting of the present invention. To the contrary, those skilled in the art should appreciate that there are numerous variations and equivalents that may be employed without departing from the scope of the present invention. Those equivalents and variations are intended to be encompassed by the present invention.

In the following description of various invention embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope and spirit of the present invention.

In the last hundred years, various strategies have been tried to locate and dispose of buried ordnance (often referred to as “demining” or “clearing”). Initially, handheld metal detectors were used to detect buried ordnance. Thereafter, mechanical techniques for either detonating or dismantling the ordnances have been performed with mixed success. In this regard, placement of buried ordnance can be performed at relatively low cost by personnel with a minimum amount of training. However, conventional clearing of a geographic area of buried ordnance is expensive, time consuming and fraught with risk. This is particularly true when a conflict zone includes various different types of ordnance; for example, there are various different types and sizes of mines in use in conflict zones. However, the physical characteristics of an anti-personnel mine make it much more difficult to detect than an anti-tank mine, which requires significantly more explosive power to achieve its destructive goal. Moreover, some anti-personnel mines are made almost entirely of non-metallic materials meant to evade metal detectors.

Still further, by design, ordnances such as mines and IEDs are configured to be places randomly without a pattern that is discernable by a passerby. Accordingly, ordnances may be buried in a geographic location in any manner that maximized destruction and deterrence of land us. This further compounds the difficulty of detecting buried ordnance locations. As a result of these challenges, some manual ordnance clearing operations have used animals, e.g., owing to their strong sense of smell that can be trained to detect explosive agents. However, the loss of life resulting from error in detection is still challenging even with trained animals. The loss of life and cost of training and replacement of such animals remains a problem. Likewise, use of robots to detect buried ordnance is also challenging when an error in detection destroys valuable, costly equipment.

Conventionally, the use of magnetometry and Ground Penetrating Radar (GPR) technologies for UXO detection have been investigated but have been determined to require significant time to survey a geographic area; in addition these technologies require generated data to be analyzed by highly specialized scientists prior to providing the data, with associated location information, to pyrotechnic personnel to physically locate, remove and neutralize the UXOs

Although GPR technology can provide superior results by providing the ability to both detect and differentiate between different substances buried underground, GPR data is incredibly complex and suffers from data integrity issues resulting from the fact that GPR images locations by radiating microwaves and detecting reflected microwave signals. More specifically, GPR technology is less effective at providing useable data in geographic areas including heterogeneous materials, e.g., rocky soil, large amounts of moisture (causing high electrical conductivity) and areas including surface gradients that skew the effect of reflected signals to be used in identifying underground objects.

Beginning in the early twenty-first century, other conventional approaches have considered the possibility of using UAVs; however, implementation has proved difficult to implement and requires extensive post field work analysis. This is because various different sensor technologies have strengths and weaknesses in what and how they detect buried material. These sensors also produce disparate types of data that are not compatible with one another and, conventionally, require expert post-field analysis to understand the sensor collected data. Still further, this sensor data must be paired with data indicating the location of where an UAV was positioned when the sensor data was gathered.

These limitations are problematic in real world situations presently experienced around the globe. For example, the current state of operation of the State Emergency Service (SES) of Ukraine utilizes UAVs to conduct a visual inspection using Electro Optical (EO) sensors for the presence of any ammunition or signs of hostilities in agricultural fields and within forest areas from heights of 80 to 250 meters; conventional UAVs utilized for this effort are limited to EO and InfraRed (IR) cameras to detect hazardous materials in a geographic area. However, this technology is limited in capability and does not provide data that may be analyzed effectively to provide accurate data indicative of the presence of UXOs.

Conventional investigations of using UAVs for magnetometry and GPR sensor surveying of geographic areas theoretically reduce the amount of time required to survey a particular size of geography; however, the need for highly specialized post-scanning analysis still prolongs the period of time for surveying and delays operation of pyrotechnic personnel to perform their jobs. As a result, use of this technology is limited.

Additionally, because of the basis for data collection in magnetometers, magnetic interference of the electrical operation of a UAV's own drive mechanisms can wreak havoc on the precision, high-resolution magnetic fields required to use magnetometry as a mechanism for detecting UXOs. Conventional research has attempted to buffer magnometric sensors by strategic placement on UAVs; however, specific design criteria for providing stable flight must also be taken into consideration. Additionally, due to the precise and limited range at which magnetometry may be used, UAVs including such technology require highly trained and controlled operation to ensure consistent and level operation of UAVs in close proximity to the ground surface. EO sensor use, i.e., visual inspection, is possible for use with UAVs but it too is limited given the level of detail required to detect anomalies or changes in surface levels.

LiDAR sensing technology is particularly useful for detecting objects that are covered by a tree canopy because LiDAR effectively penetrates the canopy to detect physical, surface terrain anomalies (e.g., gradients) and changes in the same. Thus, LiDAR data may be prioritized over other types of sensors because it is particularly adept at sensing through vegetation relative to other sensors. With regard to UXOs implemented using plastics, Synthetic Aperture Radar (SAR) is particularly adept.

IR technology is best to identify an object that has a significant heat signature relative to its surroundings (e.g., a metal disc that retains heat and, therefore, registers hotter than the surrounding grass. However, IR sensor technology is known to be quite limited in its ability to identify plastic mines based on ambient temperature differences and IR also suffers from problems in providing meaningful data when UXOs are buried near bushes and other flora.

As discussed above, it is possible to include one or more GPR sensors on the UAV-based, multi-module sensor system, such GPR sensors may be too costly in both data gathering and analytics time and resources to be useful in all implementations.

The inventors have recognized that no one particular sensor technology or sensor type provides a uniformly superior investigation tool for detecting all types of UXOs in all geographic area types, in particular, those relating to areas of agricultural cultivation. With this understanding of the deficiencies of various single sensor approaches in mind, disclosed embodiments provide a system and processes that enable detecting and identifying UXOs in near real-time using UAVs (also referred to as “drones,”) that include a plurality of sensors of different types for imaging the terrain of a geographic area to analyze the terrain and detect anomalies and/or changes that may be indicative of locations of UXOs, for example, data anomalies detected in a particular location such as soil movement activity performed in association with the burying the UXO.

In accordance with at least some disclosed embodiments, near real time geospatial analysis tools are provided using sensor data generated by various different types of IR sensors, EO sensors, SAR sensors, and LiDAR sensors (without limitation) located on a UAV.

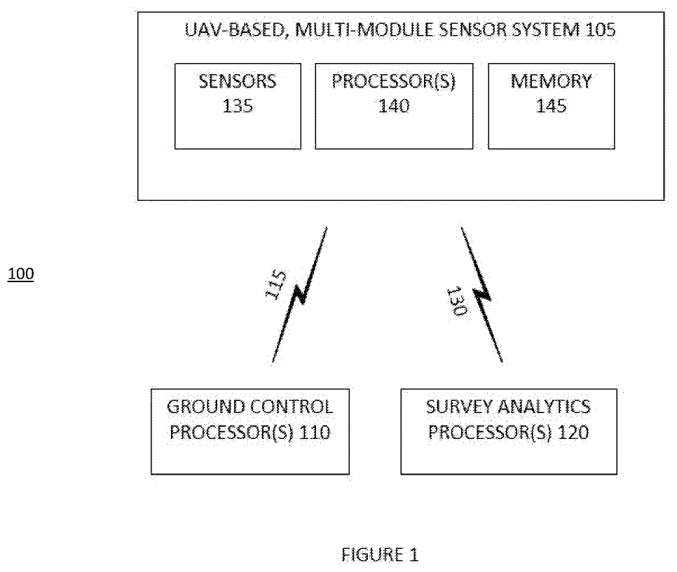

FIG. 1 illustrates an example of a remote ordnance identification and classification system including an exemplary implementation of UAV-based, multi-module sensor system functionality in accordance with disclosed embodiments. As indicated above, and illustrated in FIG. 1, the system equipment 100 may include one or more UAV-based, multi-module sensor system 105, one or more ground station processors 110 coupled to communication equipment 115 for data communication and control signal transmission along a communication link 130 for controlling the UAV-based, multi-module sensor system 105. The system equipment 100 also includes one or more surveying analytics processors 120 configured to analyze data generated by the UAV-based, multi-module sensor system 105 received via communication link 130 (or via transfer of data included in UAV memory 145, as discussed below). The UAV-based, multi-module sensor system 105 may include a plurality of sensors 135 selected from IR sensors, EO sensors, SAR sensors, and LiDAR sensor technology. These different types of sensors augment the data of each other to compensate for deficiencies of the different technologies' sensing paradigms.

Optionally, each type of sensor may be included on a UAV-based, multi-module sensor system; alternatively, multiple types of sensors including at least an EO sensor (which is generally included in commercially available UAVs, an IR sensor, and a SAR sensor are included to provide differentiated analysis and data. SAR sensors are particularly effective for UXO detection because SAR can effectively identify an object and distinguish between plastics, metals and organic material no matter the temperature of whether the UXO is lightly buried; additionally, the presence of non-organic material between the sensor UXO is not a problem that hinders detection. Likewise, EO sensor use provides visual data that may be used by pyrotechnic teams to confirm findings of other sensors.

The UAV-based, multi-module sensor system 105 also may include processing equipment 140, e.g., one or more small form factor devices, e.g., an INTEL™ Next Unit of Computing (NUC) computing elements or the like such as mini PCs, that provide processing power to provide edge computing on the data gathered at the UAV. More specifically, sensor generated data are stored in memory 145 and analyzed by the processor 140 as explained herein. Optionally, the processed sensor data may be transmitted via communication link 130 to the survey analytics processor 120 or, as explained herein transferred, post-UAV operation to the survey analytics processor 120 via connected data transfer (e.g., chip, card, or cord implemented data access).

The disclosed embodiments use multiple different types of sensors that provide different types of data simultaneously thereby enabling the ability to reduce the period of time required for surveying and providing data. The speed of data gathering and analysis is further increased by analyzing the UAV generated data on the UAV-based, multi-module sensor system by processing algorithms in the NUC implemented processing equipment 140 to provide “pre-processed” data that may be accessed immediately by pyrotechnic teams to locate, categorize and dismantle UXOs in a geographic area in one quarter the time of that conventionally possible. In fact, depending on the implementation details associated with how the data output from the NUC is provided to pyrotechnic teams, it foreseeable that UXO location and sensor generated data may be provided to pyrotechnic team personnel in “near real time,” which means, in this case, in less than five minutes from scanning by the inventive UAV-based, multi-module sensor system.

For example, as introduced above, in one potential implementation, the data generated on-board the UAV-based, multi-module sensor system 105 may be transmitted by radio communication link 130 to one or more survey analytics processors 120 (e.g., laptops, tablets or other mobile computing devices appropriate for field use) running software enabling analysis of the UAV on-board generated data to:
(1) output an indication of a GPS location of one or more potential UXOs;
(2) compare the sensor generated data with corresponding measurement data stored in a database and indicating measurement values indicative of different types of UXOs to perform identification of the type of UXO or to perform categorization of a class of UXO at the indicated location; and/or
(3) output both visual imaging information of the indicated location as well as one or more images of the identified likely UXO type or UXO class at the indicated location.

In a further variation, the on-board generated data may be provided to the survey analytics processor 120 (implemented using a laptop computer running software) that performs this processing (1-3) and transmits resulting information (e.g., files or other data) to one or more laptops, tablets or other mobile computing devices associated with each of the pyrotechnic teams surveying a geographic area for simultaneous use.

In a more utilitarian implementation, the data generated on-board the UAV-based, multi-module sensor system may be stored in memory 145 on the UAV-based, multi-module sensor system and then downloaded to a survey analytics processor 120 following completion of scanning the geographic area or a portion thereof by the UAV-based, multi-module sensor system 105. At that time, the data may be downloaded or removed from the UAV-based, multi-module sensor system 105 and accessed by survey analytics processor 120 for subsequent analytics functionality (see 1-3 above).

In at least one implantation of any of the above-described file transfer approaches, the data generated on the UAV may be provided in the form of files formatted in accordance with the KMZ protocol, or the like. KMZ files are compressed .KML files storing map locations viewable in various Geographic Information Systems (GIS) applications. Such locations are specified by latitudinal and longitudinal coordinates; the KMZ protocol enables packaging multiple files (including imaging files and constituent data) together, while also compressing the contents providing for faster transfer.

As discussed above, in accordance with disclosed embodiments, a UAV-based, multi-module sensor system 105 may be configured to provide specialized data gathering, and analysis for use in detecting and identifying potential lightly buried ordnance in an agricultural field. In accordance with at least one embodiment, the unmanned aerial control of the UAV-based, multi-module sensor system 105 may be provided by conventionally available flight control equipment using the MAVLink or Micro Air Vehicle Link protocol for communicating with UAVs.

It should be understood that the UAV component of the UAV-based multi-module sensor system 105 may be implemented using one of a number of different commercially available UAV components. For example, in accordance with at least one embodiment, the UAV component of the system may be implemented using a Skycraft Perimeter 8, which has a maximum flight time of 5 hours. Alternatively, the UAV component may be implemented using a Skycraft Perimeter 4. Still alternatively, various different types of UAV components may be used instead, for example, the EVO II, having a maximum flight time of 40 minutes and a maximum wind resistance of 39 mph, the Ruko II having a maximum flight time equal to one hour, the Ruko F11GIM2 having a maximum flight time of 56 minutes and a “level 6” wind resistance corresponding to a maximum speed up to 31 mph (approximately 25 knots). Still further, for example, Mavic 3, Ruko U11PRO, Yuneed Typhoon H Plus, and Parrot ANAFI are all potential options for the UAV component of the system. However, each of these alternatives for the UAV component of the system each have functional or structural characteristics, capabilities and characteristics that require consideration for use. Generally it should be understood that the UAV component of the system 105 should provide controlled flight out of the direct natural vision of the operator, with certain parameters concerning maximum flight endurance and wind endurance in order to provide the surveying functionality disclosed herein.

MAVLink, or any similar protocol, may be used for communication between a Ground Control Station (GCS) and a UAV, as well as for communication between the sensors located on the UAV and the other UAV equipment including data processing equipment. Such protocols may be used to transmit various control related data regarding the UAV including orientation of the vehicle, GPS location, etc.

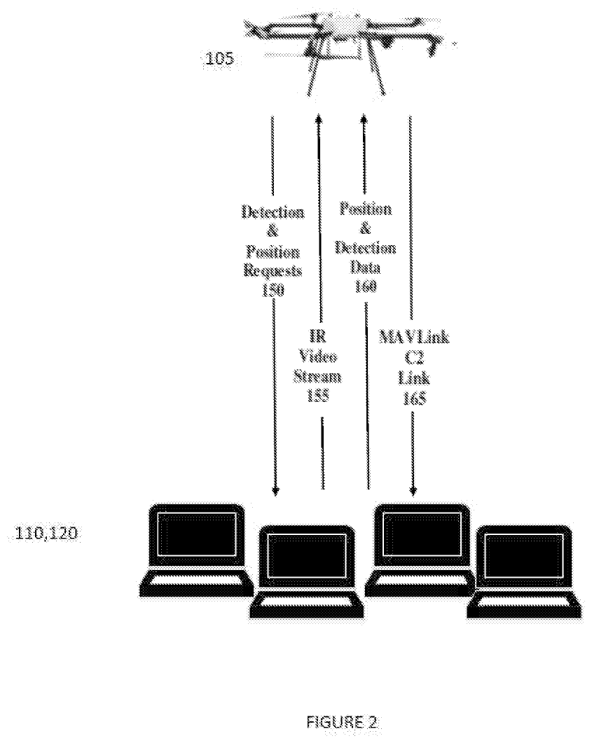

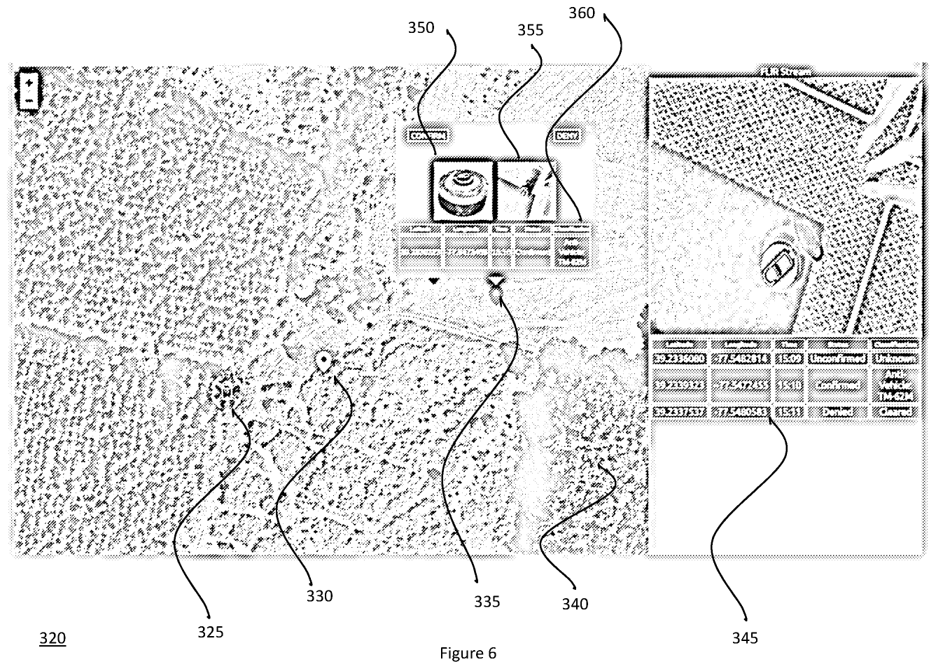

FIG. 2 illustrates an example and type of data communication performed between UAV-based, multi-module sensor system equipment and various ground based processors in accordance with the disclosed embodiments. As illustrated in FIG. 2, the UAV-based, multi-module sensor system 105 may communicate with at least one ground control processor 110 and one or more survey analytics processors 120 as part of surveying a geographic area. This communication may include the ground control processor 110 transmitting detection and position requests 150, the UAV-based, multi-module sensor system 105 communication IR video stream data 155 and position and detection data 160 (both generated by the on-board sensors 135), and a two way communication of MAVLink C2 Link data for communicating with ground control software for the UAV itself 165. When the sensor data is streamed down to the ground control processor, the information is processed and visualized through the UI that is discussed in more detail with reference to FIG. 6 herein. The communication distance is only limited by the bandwidth and limiting factors of the radio used with the UAV.

Disclosed embodiments provide a software platform that integrates the data used by the UAV with sensor data collected from the plurality of different sensors to formulate data descriptive of a particular location within a geographic area for the purposes of detecting the potential location of UXO, identification of the particular type of UXO and/or class of the UXO.

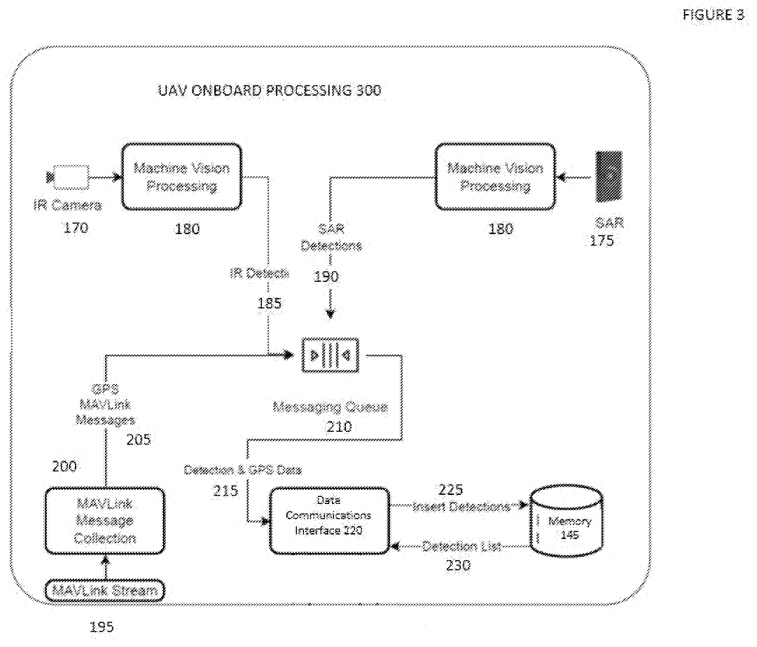

FIG. 3 illustrates an example of UAV-based, multi-module sensor system components and onboard processing functionality provided in accordance with various disclosed embodiments. As illustrated in FIG. 3, data gathering and processing performed on board the UAV-based, multi-module sensor system 105 involves the equipment of the UAV used for command and control as well as additional sensors and processing equipment (discussed above in relationship to FIGS. 1 and 2).

As explained throughout this disclosure, various commercially available sensors of different types may be affixed to the UAV-based, multi-module sensor system 105 to provide remote data gathering functionality of different characteristics. As discussed briefly above, different types of sensors are utilized because each type of sensor uses a technology that is beneficial for some situations but less so for others. Thus, using multiple sensor types enables the deficiencies of specific sensor types to be remedied by also using other sensors that do not suffer from such deficiencies. Likewise, as explained herein, simultaneous sensing of multiple characteristics at a particular location that is subsequently determine to be a UXO location (as a result) enables machine learning based improvement to identify what sensor data from multiple sensors are indicative of certain types of UXOs in certain environments for improved detection.

Thus, UAV onboard processing 300 may serve to take the data gathered from the IR camera 170 and SAR 175 (and optionally additional sensors) and processes them through machine learning software to identify potential locations of UXOs based on the SAR and IR sensor data generated data. For example, the You Only Look Once (YOLO) v3 Machine Learning algorithm model may be customized to provide near real time object recognition from the SAR sensor 175 and IR camera 170.

Thus, IR sensor generated data indicating detections 185 and SAR sensor generated data indicating detections 190 are then combined with data indicating geographic location where the data was gathered.

The illustrative exemplary software codes shown in the Appendix include one example of software code entitled Illustrative Example Code 1, which may be used to perform the functionality included in the UAV onboard processing 300 running on the equipment onboard the UAV-based, multi-module sensor system 105. Thus, it should be understood that in various embodiments, the UAV-based, multi-module sensor system 105 may perform the above-described analysis of the sensor generated data to identify the type or class of UXO detected at a particular location.

Thereafter, the data generated onboard the UAV-based, multi-module sensor system 105 may be transmitted to the survey analytics processors 120 for further analysis and output to personnel performing surveying and UXO retrieval and disposal, as discussed herein with reference to FIGS. 1, 2 and 6 and the illustrative exemplary software code shown in the examples of software code entitled Illustrative Example Codes 2 and 3, which may be used to perform further analysis of the data generated by the UAV onboard processing 300.

Additionally, EO sensor generated data (not shown) which is generated by an EO sensor that may or may not be part of the UAV itself, may also be gathered and associated with the detection data 185, 190 and the location data.

As discussed herein elsewhere, the location data may be extracted from MAVLink Stream data 19 through MAVLink message collection 200. As a result, GPS MAVLink messages 20 may be used to provide the location data.

The gathered data, e.g., including GPS data and detection data, i.e., measurement data and image data from the various sensors, may then be combined into messages and ordered into a messaging queue 210. As a result, the detection and GPS data 215 are then fed into a data communications interface 220 that may facilitate storage of the data 215 at 225 into memory 145 (see also FIG. 1), which thereafter provides access to an ordered list of detection data in a detection list 230. In accordance with implementations that provide for communication of data to survey analytics processors 120 (see also FIGS. 1 and 2), the data communication interface 220 is further configured to facilitate, control and execute transmission of the detection list 230 including the detection and GPS data 215 to the survey analytics processor 120. As a result, the detection list and associated detection and GPS data may be both stored in memory 145 and/or transmitted to the survey analytics processor(s) 120 (illustrated in FIGS. 1 and 2) for analysis and display using a mapping and sensor display software application running thereon.

Once transmitted or otherwise downloaded to the survey analytics processor(s), mapping and sensor display software running thereon may analyze the data to compare it with reference data that is indicative of different types of UXO and other reference materials as discussed in more detail with reference to FIG. 6. This reference data may be provided via access to one or more databases of IR, SAR, EO and LiDAR data associated with different types of UXOs and different categories of UXOs.

The reference data may be, for example, a combination of publicly available technical data on various UXO and land mine information, as well as testing data generated by analyzing the characteristics measured by IR, SAR, EO and LiDAR sensors when analyzing inert replicas of various UXO and landmines known to be used in combat zones such as Ukraine and the like.

In accordance with at least some embodiments the type or class of UXO may be identified by one or more survey analytics processors following transmission from the onboard the UAV-based, multi-module sensor system. Alternatively, in accordance with at least some embodiments the type or class of UXO may be identified by processing data using software code running on the UAV-based, multi-module sensor system. Thereafter, the data indicating the type or class of UXO, constituent sensor data associated with the detection event and location data for the detection event may be transmitted to the survey analytics processor(s) for further analysis and output to personnel performing surveying and UXO retrieval and disposal. In particular, as discussed herein with reference to FIGS. 1, 2 and 6 and the illustrative exemplary software code shown in the examples of software code entitled Illustrative Example Codes 2 and 3, which may be used to perform further analysis of the data generated by the UAV onboard processing 300.

For example, Illustrative Example Code 2 may be running on the survey analytics processor(s) and used to implement and provide the ability to reference and access a static reference image corresponding to the determined UXO for display on a computer terminal including or coupled to the survey analytics processor(s). Likewise, for example, Illustrative Example Code 3 may be running on the survey analytics processor(s) and used to implement and provide the ability to reference and access additional details including reference sensor data information for output to users on a computer terminal including or coupled to the survey analytics processor(s).

Turning to a more detailed explanation of the components of the UAV-based, multi-module sensor system 105, in one particular implementation example, the UAV may be a commercially available Skyfront® Perimeter 8 LRS+UAV platform with a forward-facing camera. In this regard, it should be understood that various different types of UAVs may be utilized in conjunction with the disclosed embodiments. Such commercially available UAVs include an EO sensor as part of the UAV platform. That platform may then be augmented with a IR, SAR and LiDAR sensors and at least one processing element (e.g., NUC) as explained with reference to FIG. 1).

In this particular implementation example, the Perimeter 8 LRS Plus (+) is an eight rotor variant, that provides long range communications and a power system implemented using a proprietary hybrid gasoline electric propulsion system, electronic fuel injection (Unleaded 91 Octane or above), and a reserve lithium polymer 10S battery (3-5 minutes maximum). In operation, the UAV example has a maximum endurance of over five hours without payload, three hours with a payload of 11 lb. (5 kg), two hours with a payload of 17 lb. (7.5 kg), one hour with a payload of 22 lb. (10 kg). Further, that UAV example has a maximum takeoff weight of 56 lb (25.5 kg), a maximum range (at cruise speed) of 134 miles (216 km), a maximum/minimum temperature 122° F. (50° C.)/15° F. (−10° C.), and a maximum density altitude 13,000 ft (4,000 m). The UAV example may utilize, for example, data transmission and reception at 2.4 GHz for remote control, live video, telemetry and command and control providing a range of 30 miles/50 km. In addition, a Silvus StreamCaster 4200 Enhanced Plus 2×2 MIMO Radio may be utilized with a data rate up to 100 MBps, power at 5 W-28 W IOW TX Power and frequency bands from 400 MHz to 6 GHz available.

With regard to particular implementation options for the various sensors augmenting the UAV, various IR, SAR and LiDAR sensors that are all commercially available for purchase may be used. For example, IR technology may be provided by a Forward Looking IR (FLIR) sensor such as a FLIR Vue Pro Thermal Camera providing 640×512 pixels (1266×1010 pixels in “super resolution mode”), operating at 30 Hz or 9 Hz, providing 1-14× digital zoom, and 18, 32, 45 or 69 degrees for radiometric operation (temperature measurement).

Likewise, if not included in the UAV platform itself, the EO sensor may be, for example, a forward facing First Person View (FPV) camera providing full High Definition (e.g., 1920×1080), using a ⅓″ sensor, auto white balance, wide dynamic range, backlight compensation, 10× optical zoom, and 6.9 deg to 58.2 deg, with autofocus.

Various different SAR sensors may be used in accordance with the disclosed embodiments. For example, the SAR sensor(s) may be implemented as a high 3D resolution SAR sensor, having a board size of 72 mm×140 mm, eighteen antenna arrays and expanded spatial sensing abilities, with raw signal data operating at 3.3-10 GHz (US/FCC model) (C-Band, X-Band and K-Band).

Thus, it should be understood that both the UAV and the sensor components may be commercially available, off-the-shelf components, custom components or some combination of the two. Regardless, these components are coupled together to gather, share and combine data through the disclosed novel platform of software control, communication and analytical algorithms that combine the gathered data and enable display of the data to a user that is remote from the UAV in near real time through a communications link with the UAV.

It should be understood that source code for performing the disclosed control and analysis functionality may be written in any number of software languages including C, C++, Python or the like. Likewise, it should be understood that various functionality requires compatibility with various protocols. In this regard, it should be understood that such protocols may include, for example, but without limitation, C, C++, Python, Java, SQL, SQL Lite and the like.

In accordance with at least some disclosed embodiments, the location data to be associated with the gathered sensor data is provided by utilizing the location data utilized to control travel of the UXO throughout the geographic area. As a result, equipment of these disclosed embodiments is configured to gather, use and store geolocation data for the UAV using various geolocation technologies, e.g., geopositioning that determine or estimate a geographic position of an object and provide a set of geographic coordinates (e.g., latitude and longitude) that is associated with the data gathered by the plurality of sensors at that location.

This functionality is explained specifically with reference to an implementation of the disclosed embodiments utilizing a python implemented software tool for collecting messages included in the data feed for UAV control (for example, MAVLink, used to control a MAVLink Compatible Flight Controller).

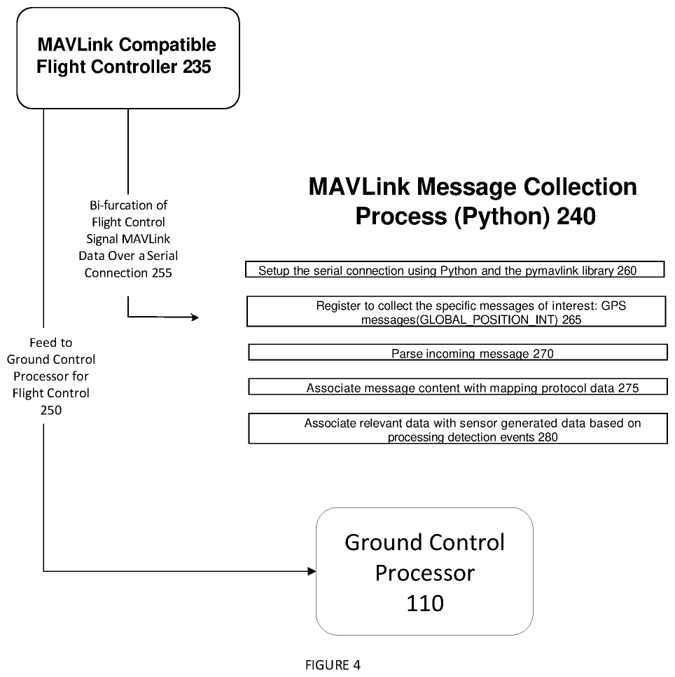

FIG. 4 illustrates one representational depiction of the operations performed to utilize flight controller software for registering UAV-based, multi-module sensor system sensor generated data with GPS location data for subsequent transmission to pyrotechnic team personnel equipment for their use. As shown in FIG. 4, data generated by the MAVLink Compatible Flight Controller 235 may be fed into a MAVLink message collection process 240 that is software implemented in, for example, Python, to separate a portion of the data sent over a serial data communication connection 245 to the ground control processor 110 (see FIG. 1). Process 240 serves to transform a portion of the MAVLink Data into data that may be associated with Leaflet data resulting from the operation of the various sensors installed on the UAV-based, multi-module sensor system 105. Leaflet is an open-source JavaScript library for mobile-friendly interactive maps. Accordingly, process 240 begins at 260, at which the serial connection for the MAVLink Data is setup using Python script and, for example, a pymavlink library, which is a low level, general purpose MAVLink message processing library conventionally used to implement MAVLink communications in many types of MA VLink systems, including, e.g., a ground control station (MAVProxy), Developer APIs (DroneKit), etc. See for example, https://mavlink.io/en/mavgen_python/.

It should be understood that the NUC implemented processing equipment discussed above, processes data onboard (EDGE) the. NUC is onboard processor for processing the sensor data on the UAV-based, multi-module sensor system. This saves time and transmission bandwidth. More specifically, the onboard processing unit may be attached to the UAV and provided with a direct serial connection with the various sensors. This enables the processing unit to preprocess the various sensor data utilizing various machine learning processes, e.g., the YOLOv3 Object Recognition model. As a result of this preprocessing, data streams with ground control processors and survey analytics processors provide information that is more quickly displayed on the UI to improve survey time and communication bandwidth requirements.

Thereafter, registration is performed to collect the specific messages of interest, i.e., GPS messages (GLOABAL_POSITION_INT) at 265. Those messages are then parsed at 270 to identify the relevant data which is associated with one of any number of conventionally available interactive map software applications at 275. For example, Leaflet, may be used for this purpose.

Control then proceeds to 280, at which the positioning data provided in accordance with the Leaflet protocol is associated with data generated from the UAV's sensor modules based on processing detection events. For example, each sensor “detection event” may be processed individually as an EO, SAR, IR or LiDAR based event (wherein the sensor has generated data indicating detection of a potential UXO location). Therefore, the system generated data may be displayed individually, collectively, e.g., by sensor type, or merged to provide a more accurate identification of a particular event. Note, however, the ordering of associating the data in 270-285 is not specifically required and may be performed simultaneously or in other orders.

Meanwhile, the bifurcated feed from the MAVLink Compatible Flight Controller continues to be communicated via a communication link 245 to the ground control processor 110 (see FIG. 1).

The illustrative exemplary software codes shown in the Appendix include one example of software code entitled Illustrative Example Code 5, which may be used to perform the functionality included in the UAV onboard processing 300 running on the equipment onboard the UAV-based, multi-module sensor system 105 to process a detection event from, for example, an EO sensor or an IR sensor. Thus, it should be understood that in various embodiments, the UAV-based, multi-module sensor system 105 may perform the above-described analysis of the sensor generated data to identify a potential location of a UXO based on that sensor data.

Further, the illustrative exemplary software codes shown in the Appendix include one example of software code entitled Illustrative Example Code 6, which may be used to perform the functionality included in the UAV onboard processing 300 running on the equipment onboard the UAV-based, multi-module sensor system 105 to process a detection event from a SAR sensor. Thus, it should be understood that in various embodiments, the UAV-based, multi-module sensor system 105 may perform the above-described analysis of the sensor generated data to identify a potential location of a UXO based on that sensor data.

Still further, the illustrative exemplary software codes shown in the Appendix include one example of software code entitled Illustrative Example Code 7, which may be used to perform the functionality included in the UAV onboard processing 300 running on the equipment onboard the UAV-based, multi-module sensor system 105 to process a detection event based on data generated by multiple sensors generating data indicative of detection events. For example, detection events from different sensor types may be tied together in cross registration with one another if they occur within a specific period of time, for example but not limited to, three seconds. This would, therefore, result in a cross-registered or combined detection event having increased likelihood of a UXO being detected at the particular location of the event.

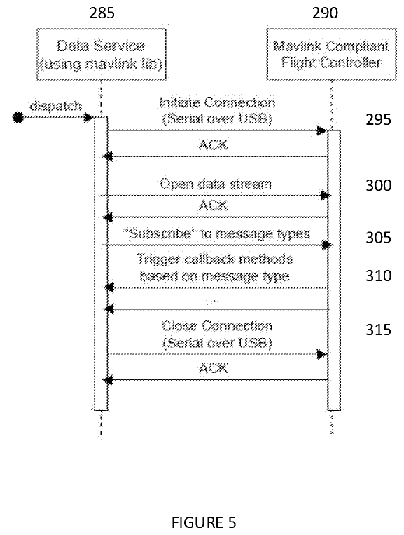

FIG. 5 illustrates a further representational depiction of the communications operations performed to utilize flight controller software for registering UAV-based, multi-module sensor system, sensor generated data with GPS location data in accordance with various disclosed embodiments. FIG. 5 illustrates an alternative depiction of the above described operations from a signaling and response format required for communication between the data service (using a MAVLink library) 285 and a MAVLink compliant flight controller 290 (indicated as 235 in FIG. 4). As shown in FIG. 5, the feed from the MAVLink compliant flight controller 290 is bifurcated and a part of it is re-used to enable the sensor generated data to be tied to the particular location at which it is collected. This involves initiating a serial connection over the USB with the flight controller 290 at 295, which is acknowledged thereafter. A data stream is then opened and acknowledgement is sent at 300. Thereafter, various message types are “subscribed” to at 305, which triggers callback method operations 310 based on message type discussed above. As a result of completion of these operations, the connection over the serial USB connection may be initiated and acknowledged at 315.

The illustrative exemplary software codes shown in the Appendix include one example of software code entitled Illustrative Example Code 4, which may be used to perform the functionality included in the UAV onboard processing 300 running on the equipment onboard the UAV-based, multi-module sensor system 105 to bifurcate the flight controller data for use in associating the location of the system 105 with the data generated at that location by the system 105. For GPS correlation, the geographical data may be updated at regular intervals to enable registering the detection events with the location of the event detected. Thus, it should be understood that in various embodiments, the UAV-based, multi-module sensor system 105 may perform the above-described analysis of the sensor generated data to identify a potential location of a UXO.

FIG. 6 illustrates an example of a User Interface (UI) 320 generated and output on one or more computers including survey analytics processors in accordance with various disclosed embodiments. Following access to data generated by the one or more UAV-based, multi-module sensor systems (see, for example, 105 of FIG. 1), one or more ground station processors (see, for example, 110 and 120 of FIG. 1) may analyze data generated by the UAV-based, multi-module sensor system. Thus, FIG. 6 illustrates an example of a UI 320 including various image data and other sensor generated on the UAV-based multi-module sensor system as well as data pulled from one or more databases including UXO reference data. As shown in FIG. 6, such a UI 320 may include a visual depiction of the geographic area 340 to provide context for the displayed data.

This image data associated with the geographic area 340 may be generated by the one or more UAV-based, multi-module sensor systems and/or may be accessed, downloaded and stored from a satellite imagery generated image, a reference map image generated by a third party or various other image data that may be available and sufficient to enable guidance of pyrotechnic team personnel to locations determined to be potential locations of UXOs.

As illustrated in FIG. 6, the geographic area image data 340 may be overlayed with indicators of locations of detected potential UXOs 330, 335. In this way, information is output that enables one or more users to identify a potential pattern of UXOs within a geographic area 340, for example, patterns in how the UXOs were buried and/or patterns of potential UXO locations that may be followed by pyrotechnic team personnel to most efficiently investigate those locations for potentially removing and neutralizing those UXOs.

In addition, if the UAV-based, multi-module sensor system is transmitting sensor and location data to survey analytics processor(s) during flight time of the UAV-based, multi-module sensor system, a present location of the UAV-based, multi-module sensor system during flight. Such functionality may be particularly useful if personnel determine that additional data should be gathered from various locations or regions of the geographic area.

In addition, UAV-based, multi-module sensor system data may include location data (longitude and latitude data) and sensor generated data 360, which may be displayed in conjunction with a particular location 335 under present examination (this may be established by hovering over a location or otherwise selecting the potential location to trigger display of additional data). Optionally, as shown in FIG. 6, the sensor generated data 360 may also include image data 355 indicating an image generated by one of the sensors on the UAV, e.g., the EO sensor for review by pyrotechnic team personnel. Optionally, the sensor generated data 355, 360 may also be displayed in a larger sub-window 345.

Sensor generated data 360 may include, for example, identification or categorization data indicating a proposed identification of a particular UXO type (e.g., make and model) located at a particular location or a proposed categorization/classification of a UXO class at a location.

In accordance with some disclosed embodiments, the data generated by the plurality of sensors may be analyzed and compared with reference data to perform object recognition analysis, for example, to make an identification of a buried object based on the sensor data generated at the location of the detected object. In addition, or in the alternative, the data generated by the plurality of sensors may be analyzed and compared with reference data to perform categorization of the detected objects, e.g. a type of UXO or a categorization/classification of the detected object as not a UXO.

Thus, it should be understood that each of the following information may be generated and output via the UI of the survey analytics processor:
output an indication of one or more GPS locations of potential UXOs;
output of sensor generated data gathered including image data at the one or more GPS locations;
   output of reference image data and/or other associated data corresponding to one or more UXOs identified as possible UXOs, or classes of UXOs, located at the one or more GPS locations.

Thus, the sensor generated data measurement data stored in a database and indicating measurement values indicative of different types of UXOs to perform identification of the type of UXO or to perform categorization of a class of UXO at the indicated location and/or output both visual imaging information of the indicated location as well as one or more images of the identified likely UXO type or UXO class at the indicated location(s).

Additionally, optionally reference data 350 may be augmented with reference data including, for example, image data including one or more images of UXOs that have been determined to potentially correspond to the sensor generated data gathered by the UAV-based, multi-module sensor system. This reference image data 350 may be used by pyrotechnic team personnel to compare with image data gathered by the UAV-based multi-module sensor system so that they can make an informed decision about whether the sensor data (in particular the gathered image data) is, in fact, an accurate indicator that the UXO included in the reference data 350.

Output data may include an indication of a number of UXOs found in a geographic area to date, a radius around the geographic the area or other data indicative of the likelihood of finding UXOs of a particular type in the geographic area. Moreover, additional data associated with the removal and neutralization of the detected objects may also be identified, stored and output via the UI, e.g., warnings regarding particular installation details for a UXO type discovered in an area around the geographic area.

As part of operation and maintenance associated with the remote ordnance identification and classification system including the UAV-based multi-module sensor system, the data from various different sensor types may be analyzed at a point in time following initial analysis of the sensor software for location detection, identification/categorization analysis for the purpose of formulating more informed analytics algorithms based on the different and disparate data generated by each of sensors through sensor fusion functionality. More specifically, it should be further appreciated that such sensor data disagreement creates confusion and anxiety for pyrotechnic personnel required to neutralize UXOs. Thus, continuously improving the algorithms for performing multi-type sensor fusion increases accuracy of the disclosed system. Performing “after action” analysis builds a set of potentially corrective changes to detection and identification software or, at least, increased accuracy or alternative approaches for data sets from different sensor types.

Thus, it should be appreciated that, in accordance with disclosed embodiments, data generated by the multiple types of sensors may be analyzed to determine likelihood of accuracy based on analysis of the data indicating that at least a plurality of the multiple types of sensors indicate characteristic data that is in agreement regarding the potential presence of an unexploded ordnance. For example, a SAR sensor may detect data indicative of a “detection event” that is consistent with a metal based UXO, thereby leading to categorization of the material as an unknown UXO; however, the EO camera may image the object to provide image data that is analyzed and is easily recognizable as a child's baseball bat left out in a field.

Such “sensor data agreement” issues may occur periodically as the disclosed system learns by encounters subsets of data results appear uniquely consistent with one identification but are encountered with subsets of data that are completely inconsistent with those results. Such scenarios are often new circumstances not previously encountered and requiring establishing or adapting old UXO analytics algorithms when, for example, an IR sensor identifies a circular heat signature that appears to be UXO (e.g., a mine), but the SAR sensor and the EO camera indicate that the object is organic material, actually a groundhog sitting on top of the ground surface. In such a situation, previous analytics algorithms may be modified to consider data results from SAR and/or EO sensors that are inconsistent with IR results, to consider various additional data or perform additional scans of the location to perform a new operation to acquire data, e.g., a comparison of a detected position of the potential UXO from previous data to present data to perform change detection at the particular position; such an approach would enable determining whether the detected object was actually moving, thereby indicating fauna of the geographic area. It should be appreciated that this after-action analysis for reformulation of analytics algorithms may be performed on an automated, semi-automated or fully-automated paradigm.

This may be performed by using machine learning algorithms on previously collected data set (e.g., with reference to particular locations and geographic areas). Previous data sets may be captured post survey and may be stored in a development version of the UI. This previously collected data can then be recalled by development engineers to apply a variation of update Machine Learning models to improve upon the accuracy of the information.

For example, various (e.g., a plurality of) tree decision algorithms (optionally written in Python) and the YOLOv3 Object Recognition model may be used to perform various functions including at least: detecting changes in geographic areas to perform detection of potential locations of UXOs and, secondly, performing analysis of sensor data to perform UXO identification (or categorization).

In accordance with disclosed embodiments, the data generated by the plurality of sensors and data relating to subsequent removal and neutralization of detected objects may be used to further refine the change detection, identification and categorization analyses through machine learning to assist in facilitating both sensor fusion functionality. Additionally, that data may also be used in machine learning to further analyze what patterns of sensor data from different types of sensors are indicative of UXOs eventually removed and neutralized. In this regard, the data gathered at a particular location may be associated with data indicating the location at which the data was gathered as well as documentation indicating whether and what type of ordnance was subsequently determined to located at a particular location. This combination of data may be referred to as a “survey-neutralization profile.”

In accordance with disclosed embodiments, scanning and analysis of a particular geographic area (referred to herein as “surveying”) may be performed as a single event or may be performed on a periodic basis. For example, in accordance with at least some disclosed embodiments, the plurality of sensors may generate sensor data that enables change detection analysis that analyzes the terrain of a geographic area for one or more changes in analyzed characteristics since a last analysis was performed for the geographic area. This type of change detection analysis may be used to identify locations for further analysis as a potential cite of a UXO. Alternatively, or in addition, the data generated by the plurality of sensors may also be analyzed to identify values of sensed characteristics that indicative of a potential cite of a UXO. In this way, multiple surveys of a particular geographical area need not be required to identify locations for further analysis as a potential cite of a UXO.

Although technical utility of the disclosed embodiments has been described with reference to identifying locations of potential UXOs, the remote ordnance identification and classification system includes various components that may also be used to assist in identifying mass graves based on, for example, change detection resulting from determining whether a geographic area has changed from one survey to another. Optionally, software for this additional functionality may loaded and running in the background while UXO location detection is performed.

More specifically, LiDAR sensing technology may be particularly useful for detecting objects that are covered by a tree canopy because LiDAR effectively penetrates the canopy to detect physical terrain anomalies (e.g., gradients) and changes in the same. For example, if a soil disturbance appears to be a mound above the ground surface, the location of the detected change may be flagged for further evaluation either remotely using the UAV-based multi-module sensor system of by personnel travelling to the location.

It should be understood that the functionality described in connection with various described components of various invention embodiments may be combined or separated from one another in such a way that the architecture of the invention is somewhat different than what is expressly disclosed herein. Moreover, it should be understood that, unless otherwise specified, there is no essential requirement that methodology operations be performed in the illustrated order; therefore, one of ordinary skill in the art would recognize that some operations may be performed in one or more alternative order and/or simultaneously. Thus, various components of the invention may be provided in alternative combinations operated by, under the control of or on the behalf of various different entities or individuals.

It should be understood that various aspects of the disclosed embodiments and the disclosed functionality are implemented using software running on a plurality of networked computers.

It should further be understood that various connections are set forth between elements in the description herein; however, these connections in general, and, unless otherwise specified, may be either direct or indirect, either permanent or transitory, and either dedicated or shared, and that this specification is not intended to be limiting in this respect.

Additionally, it should be understood that, in accordance with at least one embodiment of the invention, system components may be implemented together or separately and there may be one or more of any or all of the disclosed system components. Further, system components may be either dedicated systems or such functionality may be implemented as virtual systems implemented on a plurality of general purpose equipment via software implementations providing the functionality described herein. Thus, it should be understood that components disclosed herein may be used in conjunction with, as described above, other components, for example a computer processor.

It should be understood that the operations explained herein may be implemented in conjunction with, or under the control of, one or more general purpose computers running software algorithms to provide the presently disclosed functionality and turning those computers into specific purpose computers.

Moreover, those skilled in the art will recognize, upon consideration of the above teachings, that the above exemplary embodiments may be based upon use of one or more programmed processors programmed with a suitable computer program. However, the disclosed embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Moreover, it should be understood that control and cooperation of the above-described components may be provided using software instructions that may be stored in a tangible, non-transitory storage device such as a non-transitory computer readable storage device storing instructions which, when executed on one or more programmed processors, carry out the above-described method operations and resulting functionality. In this case, the term non-transitory is intended to preclude transmitted signals and propagating waves, but not storage devices that are erasable or dependent upon power sources to retain information.

Those skilled in the art will appreciate, upon consideration of the above teachings, that the program operations and processes and associated data used to implement certain of the embodiments described above can be implemented using disc storage as well as other forms of storage devices including, but not limited to non-transitory storage media (where non-transitory is intended only to preclude propagating signals and not signals which are transitory in that they are erased by removal of power or explicit acts of erasure) such as for example Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies without departing from certain embodiments. Such alternative storage devices should be considered equivalents.

While certain illustrative embodiments have been described, it is evident that many alternatives, modifications, permutations and variations will become apparent to those skilled in the art in light of the foregoing description. Accordingly, the various embodiments of, as set forth above, are intended to be illustrative, not limiting. Various changes may be made without departing from the spirit and scope of the invention.

As a result, it will be apparent for those skilled in the art that the illustrative embodiments described are only examples and that various modifications can be made within the scope of the invention as defined in the appended claims.

APPENDIX
Illustrative Exemplary Code 1:

```
pred = self.interface(dt, im, augment=False, visualize=visualize)
p, proto, masks = self.apply_nms(dt, pred)
for i, det in enumerate(p):
  seen += 1
  if self.is_stream:
    pred, im0, _ = path[0], im0s[0].copy( ), self.dataset.count
  else:
    pred, im0, _ = path[0], im0s.copy( ), self.dataset.count
  pred = Path(pred)
  s += f‘{i}’
  curr_frames[i] = im0
  s += ‘%gx%g ’ % im.shape[2:] # print string
  imc = im0
  if self.is_stream:
    im0 = np.ascontiguousarray(im0)
  annotator = Annotator(
    im0, line_width=self.line_thickness, example=str(self.names))
  if hasattr(tracker_list[i], ‘tracker’) and hasattr(tracker_list[i].tracker, ‘camera_update’):
    # camera motion compensation
    if prev_frames[i] is not None and curr_frames[i] is not None:
      tracker_list[i].tracker.camera_update(
        prev_frames[i], curr_frames[i])
  if predictions_callback is not None:
    detections_list = [ ]
  if det is not None and len(det):
    detection = [ ]
    if self.is_seg:
      shape = im0.shape
      masks.append(process_mask(
        proto[i], det[:, 6:], det[:, :4], im.shape[2:], upsample=True))
      det[:, :4] = scale_boxes(
        im.shape[2:], det[:, :4], shape).round( )
    else:
      det[:, :4] = scale_boxes(
        im.shape[2:], det[:, :4], im0.shape).round( )
    for c in det[:, 5].unique( ):
      n = (det[:, 5] == c).sum( )
      s += f“{n} {self.names[int(c)]}{‘s’ * (n > 1)}, ”
    # pass detections to the tracker
    with dt[3]:
      outputs[i] = tracker_list[i].update(det.cpu( ), im0)
    # draw boxes for visualization
    if len(outputs[i]) > 0:
      log.info(“Detections Found: { }”.format(len(outputs[i])))
      for j, (output) in enumerate(outputs[i]):
        bbox = output[0:4]
        id = output[4]
        cls = output[5]
        conf = output[6]
        c = int(cls) # integer class
        id = int(id) # integer id
        class_name = f‘{self.names[c]}’
        label = (f‘{id} {class_name} {conf:.2f}’)
        detection.append((bbox, id, cls, class_name, conf))
        color = colors(c, True)
        annotator.box_label(bbox, label, color=color)
```

Illustrative Exemplary Code 2:

```
const vehicleMine = require(‘./vehicleMine.png’);
const testimg2 = require(‘./FLIR.png’)
const defaultImg = require(‘./DefaultImg.png’);
const directionalMine = require(‘./directionalMine.png’);
const claymore = require(‘./claymore.png’);
const boundingMine = require(‘./boundingMine.png’);
const barMine = require(‘./barMine.png’);
const handgrenade = require(‘./handgrenade.png’);
const directionalMine1 = require(‘./directionalMine1.jpeg’);
const claymore1 = require(‘./claymore1.jpeg’);
const boundingMine1 = require(‘./boundingMine1.jpeg’);
const barMine1 = require(‘./barMine1.jpeg’);
const handgrenade1 = require(‘./handgrenade1.jpeg’);
const vehicleMine1 = require(‘./vehicleMine1.jpeg’);
const car = require(‘./car.jpeg’);
const train = require(‘./car.jpeg’);
const classTypes = {
  “claymore”: claymore, “car”: car, “vehicle-mine”: vehicleMine,
  “directional-mine”: directionalMine, “bounding-mine”: boundingMine, “bar-mine”: barMine,
  “hand-grenade”: handgrenade, “train”: train
}
```

Illustrative Exemplary Code 3:

```
<Popup className=″drone-popup″>
  {props.type != 2 ?
    <div className=″popupLayout″ style={popupContent} >
      <div className=“imageLayout” >
        <img
          alt=″tempalt″
          className=″img-fluid″
          src={classTypes[props.class_type]}
          height=″150vh″ width=″150vw″ />
        <br> </br>
        <b>PDF</b>
      </div>
      <div className=″imageLayout″>
        <img src={‘data:image/jpeg;base64,${props.img}‘} height=″150vh″
width=″150vw″ />
        <br></br>
        <b>FLIR Image</b>
      </div>
    </div>
    : <div className=″popupLayout″ style={popupContent}></div>
  }
  <br></br>
```

Illustrative Exemplary Code 4:

```
var forever chan struct{ }
log.Printf(“Starting Message Receiver\n”)
go func( ) {
  for {
    select {
    case d := <-cvMsgs:
      cnt++
      // handle data coming from CV queue here
      handleVisionObjectData(d.Body, *flightControllerData)
    case d2 := <-walabotMsgs:
      cnt++
      //handle data coming from Walabot queue
      handleWalabotData(d2.Body, *flightControllerData)
    case d3 := <-fcMsgs:
      cnt++
      //handle data coming from flight controller queue
      handleFlightControllerData(d3.Body)
    case d4 := <-cvImgMsgs:
      cnt++
      //handle data coming from CV image queue
      handleVisionImageData(d4.Body)
    }
  }
}( )
//log.Printf(“ [*] Waiting for messages. To exit press CTRL+C”)
<-forever
```

Illustrative Exemplary Code 5:

```
func handleVisionObjectData(data [ ]byte, fcData types.FlightController) {
  /*
    Planning on how to handle data from CV queue
    1. Unmarshal data into VisionDetectedObject
    2. Create a new VisionDetectedObject
    3. Add VisionDetectedObject to detectedObjectsCache
    4. Create a new Hit or get existing Hit
    5. Add Hit to detectionsByTime or update existing Hit
    6. Add VisionDetectedObject to same key as Hit in detectedObjectsByTimeCache
  */
  //determine how data from CV queue input
  log.Printf(“handleVisionObjectData message --> %v\n”, string(data))
  t := time.Now( )
  timeToTheSecond := t.Round(time.Duration(detectionRoundingFactor) * time.Second)
  entry := detectionsByTime[timeToTheSecond.Unix( )]
  visionDetectedObject := types.VisionDetectedObject{ }
  if err := json.Unmarshal(data, &visionDetectedObject); err != nil {
    log.Printf(“Error unmarshalling vision object data: %v”, err)
    return
  }
  // Add VisionDetectedObject to detectedObjectsCache
  detectedObjectsCache[visionDetectedObject.ID] = visionDetectedObject
  // Add VisionDetectedObject to same key as Hit in detectedObjectsByTimeCache
  allDetectedObjects, ok := detectedObjectsByTimeCache[timeToTheSecond.Unix( )]
  if !ok {
    allDetectedObjects = [ ]int{visionDetectedObject.ID}
  }
  allDetectedObjects = append(allDetectedObjects, visionDetectedObject.ID)
  detectedObjectsByTimeCache[timeToTheSecond.Unix( )] = allDetectedObjects
  // Create a new Hit / Update existing Hit
  if entry.Hits == nil {
    entry.Hits = make(map[int]*types.Hit, 1)
  }
  hit, ok := entry.Hits[types.TypeIR]
  if ok {
    // This is a Sample Variance rather than an average
    oldConfidence := hit.Confidence
    oldConfWeight := oldConfidence * (float32(len(allDetectedObjects)) − 1) /
float32(len(allDetectedObjects)) // oldConfidence * (n − 1) / n
    newConfWeight := visionDetectedObject.Confidence / float32(len(allDetectedObjects))
// newConfidence / n
    newConfidence := oldConfWeight + newConfWeight
    hit.Confidence = newConfidence
    hit.Classifier = append(hit.Classifier, visionDetectedObject.ClassifierName)
    //newConfidence := (curConfidence + visionDetectedObject.Confidence) /
float32(len(allDetectedObjects))
    entry.Hits[types.TypeIR] = hit
  } else {
    hit := types.Hit{
      Time: t.Unix( ),
      Type: types.TypeIR,
      Classifier: [ ]string{visionDetectedObject.ClassifierName},
      Confidence: visionDetectedObject.Confidence,
      Image: visionDetectedObject.Image,
    }
    entry.Hits[types.TypeIR] = &hit
    entry.Time = t.Unix( )
  }
  // Fill in the rest of the info
  entry.FlightControllerData = &fcData
  detectionsByTime[timeToTheSecond.Unix( )] = entry
}
```

Illustrative Exemplary Code 6:

```
func handleWalabotData(data [ ]byte, fcData types.FlightController) {
  // determine how the data is coming into walabot queue
  log.Printf(“handleWalabotData message --> %s\n”, data)
  t := time.Now( )
  timeToTheSecond := t.Round(time.Duration(detectionRoundingFactor) * time.Second)
  log.Printf(“Date parsed: %v\n”, timeToTheSecond.Unix( ))
  entry := detectionsByTime[timeToTheSecond.Unix( )]
  if entry.Hits == nil {
    entry.Hits = make(map[int]*types.Hit, 1)
  }
  hit := types.Hit{
    Time: t.Unix( ),
    Type: types.TypeSAR,
  }
  entry.Hits[types.TypeSAR] = &hit
  entry.Time = timeToTheSecond.Unix( )
  entry.FlightControllerData = &fcData
  detectionsByTime[timeToTheSecond.Unix( )] = entry
}
for {
  toDelete := make([ ]int64, 0)
  for i, entry := range detectionsByTime {
    if flightControllerData == nil {
      continue
    }
    detection := entry
    isSAR := detection.Hits[types.TypeSAR] != nil
    isIR := detection.Hits[types.TypeIR] != nil
    if isSAR && isIR {
      log.Printf(“Adding FUSED Detection #%d”, i)
      detection.Type = types.TypeFused
    } else if isIR {
      log.Printf(“Adding IR Detection #%d”, i)
      detection.Type = types.TypeIR
    } else if isSAR {
      log.Printf(“Adding SAR Detection #%d”, i)
      detection.Type = types.TypeSAR
    }
```

Illustrative Exemplary Code 7:

```
    detection.FlightControllerData = flightControllerData
    if len(detection.Hits) > 0 {
      dEntry := types.DetectionEntry{
        MissionId: missionId,
        Summary: “”,
        Detection: &detection,
      }
      if detectionId, err := database.InsertDetection(db, dEntry); err != nil {
        log.Printf(“Error inserting detection: %v”, err)
        continue
      } else {
        newObjects := make([ ]types.VisionDetectedObject, 0)
        for _, objID := range detectedObjectsByTimeCache[i] {
          obj := detectedObjectsCache[objID]
          newObjects = append(newObjects, obj)
        }
        if _, err := database.InsertIRObjects(db, newObjects, detectionId, missionId); err != nil {
          log.Printf(“Error inserting detected objects: %v”, err)
          continue
        }
        if _, err := database.InsertDetectionISObjectCatalog(db, detectedObjectsByTimeCache[i],
detectionId); err != nil {
          log.Printf(“Error inserting detected objects: %v”, err)
          continue
        }
      }
    }
    // Remove the entry after it's made it into the db
    toDelete = append(toDelete, i)
  }
  for _, item := range toDelete {
    delete(detectionsByTime, item)
  }
  detects := database.GetDetections(db, missionId)
  log.Printf(“Total detections: %d”, len(detects))
  time.Sleep(time.Millisecond * time.Duration(evalLoopPeriod))
}
```

We claim:

1. A system for detecting potential locations of unexploded ordnance in near real-time in a geographic area, the system comprising:
at least one unmanned aerial vehicle configured to gather sensor data using multiple types of sensors regarding locations included in the geographic area during a survey of the geographic area;
at least one ground control processor configured to communicate with a flight controller included in the at least one unmanned aerial vehicle to enable remote control of the at least one unmanned aerial vehicle to complete the survey of the geographic area; and
at least one survey analytics processor configured to communicate with the at least one unmanned aerial vehicle to receive sensor data generated by the multiple types of sensors regarding locations included in the geographic area and location data generated by the flight controller, analyze the received data and identify potential locations of unexploded ordnance based on analysis of the received data, wherein the analysis includes comparing the received data with reference data indicating a plurality of characteristics known to correspond to unexploded ordnance.

2. The system of claim 1, wherein the at least one unmanned aerial vehicle includes a plurality of sensors of multiple types configured to generate sensor data regarding locations included in the geographic area during the survey of the geographic area.

3. The system of claim 2, wherein the plurality of sensors of multiple types includes an electro optical sensor and a synthetic aperture radar sensor.

4. The system of claim 2, wherein the plurality of sensors of multiple types includes an infra-red sensor and a synthetic aperture radar sensor.

5. The system of claim 2, wherein the plurality of sensors of multiple types includes a LiDAR sensor and a synthetic aperture radar sensor.

6. The system of claim 2, wherein the plurality of sensors of multiple types includes an electro optical sensor, an infra-red sensor, a LiDAR sensor and a synthetic aperture radar sensor.

7. The system of claim 1, wherein the generated sensor data images terrain of the geographic area to analyze the terrain and detect anomalies that indicate potential locations of unexploded ordnance.

8. The system of claim 1, wherein the generated sensor data images terrain of the geographic area to analyze the terrain and detect changes in sensor data that indicate potential locations of unexploded ordnance.

9. The system of claim 8, wherein the changes are detected based on sensor data generated in at least two surveys, which are compared to detect changes therebetween.

10. The system of claim 1, wherein the at least one unmanned aerial vehicle includes at least one computer element configured process the sensor data to detect characteristics of the terrain at locations in the geographic area and associate the detected characteristics with data indicating the location at which the sensor data was generated.

11. The system of claim 10, wherein the terrain characteristic data and data indicating the location associated with that terrain characteristic data is transmitted to the at least one survey analytics processor during the survey of the geographic area for further analysis and output via user interface of the at least one survey analytics processor.

12. The system of claim 10, wherein the terrain characteristic data and data indicating the location associated with that terrain characteristic data is downloaded to the at least one survey analytics processor following completion of scanning performed by the at least one unmanned for further analysis and output via user interface of the at least one survey analytics processor.

13. The system of claim 10, wherein the data indicating the location at which the sensor data was generated is provided by parsing message data from a data stream used by the at least one unmanned aerial vehicle to control guidance.

14. The system of claim 1, wherein data generated by the multiple types of sensors is analyzed to determine likelihood of accuracy based on analysis of the data indicating that at least a plurality of the multiple types of sensors indicate characteristic data that is in agreement regarding the potential presence of an unexploded ordnance.

15. The system of claim 1, wherein the comparison of the received data with reference data indicating a plurality of characteristics known to correspond to unexploded ordnance is used to generate an identification of a type of unexploded ordnance, and wherein the identification of the type of unexploded ordnance is output via the at least one survey analytics processor along with a photographic image of the location included in the received data and generated by one of the multiple sensors.

16. The system of claim 1, wherein the comparison of the received data with reference data indicating a plurality of characteristics known to correspond to unexploded ordnance is associated with documentation indicating whether and what unexploded ordnance type was subsequently located at a particular location to provide a survey-neutralization profile for a particular location, wherein the survey-neutralization profile data is analyzed by machine learning algorithms to increase accuracy of analysis of sensor generated data to detect the potential presence of unexploded ordnance and/or to identify ordnance type.

17. A method for detecting potential locations of unexploded ordnance in near real-time in a geographic area, the method comprising:
gathering sensor data via at least one unmanned aerial vehicle using multiple types of sensors regarding locations included in the geographic area during a survey of the geographic area;
communicating between at least one ground control processor and a flight controller included in the at least one unmanned aerial vehicle to enable remote control of the at least one unmanned aerial vehicle to complete the survey of the geographic area; and
communicating between at least one survey analytics processor and the at least one unmanned aerial vehicle to receive at least some portion of sensor data generated by the multiple types of sensors regarding locations included in the geographic area and location data generated by the flight controller;
analyzing data received from the at least unmanned aerial vehicle to identify potential locations of unexploded ordnance based on analysis of the received data, wherein the analysis includes comparing the received data with reference data indicating a plurality of characteristics known to correspond to unexploded ordnance.

18. The method of claim 17, wherein the gathering of sensor data is performed using a plurality of sensors of multiple types configured to generate sensor data regarding locations included in the geographic area during the survey of the geographic area.

19. The method of claim 18, wherein the plurality of sensors of multiple types includes an a synthetic aperture radar sensor and at least one of an infra-red sensor, and a LiDAR sensor.

20. The method of claim 17, wherein the generated sensor data images terrain of the geographic area to analyze the terrain and detect anomalies that indicate potential locations of unexploded ordnance.

21. The method of claim 17, wherein the generated sensor data images terrain of the geographic area to analyze the terrain and detect changes in sensor data that indicate potential locations of unexploded ordnance.

22. The method of claim 21, wherein the changes are detected based on sensor data generated in at least two surveys, which are compared to detect changes therebetween.

23. The method of claim 17, further comprising utilizing at least one computer element included in the at least one unmanned aerial vehicle to process the sensor data to detect characteristics of the terrain at locations in the geographic area and associate the detected characteristics with data indicating the location at which the sensor data was generated.

24. The method of claim 23, further comprising transmitting the terrain characteristic data and data indicating the location associated with that terrain characteristic data to the at least one survey analytics processor during the survey of the geographic area for further analysis and output via user interface of the at least one survey analytics processor.

25. The method of claim 23, further comprising downloading the terrain characteristic data and data indicating the location associated with that terrain characteristic data to the at least one survey analytics processor following completion of scanning performed by the at least one unmanned for further analysis and output via user interface of the at least one survey analytics processor.

26. The method of claim 23, further comprising providing the data indicating the location at which the sensor data was generated by parsing message data from a data stream used by the at least one unmanned aerial vehicle to control guidance.

27. The method of claim 17, further comprising analyzing the data generated by the multiple types of sensors to determine likelihood of accuracy based on analysis of the data indicating that at least a plurality of the multiple types of sensors indicate characteristic data that is in agreement regarding the potential presence of an unexploded ordnance.

28. The method of claim 17, wherein the comparison of the received data with reference data indicating a plurality of characteristics known to correspond to unexploded ordnance is used to generate an identification of a type of unexploded ordnance, and wherein the identification of the type of unexploded ordnance is output via the at least one survey analytics processor along with a photographic image of the location included in the received data and generated by one of the multiple sensors.

29. The method of claim 17, wherein the comparison of the received data with reference data indicating a plurality of characteristics known to correspond to unexploded ordnance is associated with documentation indicating whether and what unexploded ordnance type was subsequently located at a particular location to provide a survey-neutralization profile for a particular location, wherein the survey-neutralization profile data is analyzed by machine learning algorithms to increase accuracy of analysis of sensor generated data to detect the potential presence of unexploded ordnance and/or to identify ordnance type.
